(19) United States
(12) Patent Application Publication
(10) Pub. No.: US 2024/0195189 A1
(43) Pub. Date: Jun. 13, 2024

(54) MULTI-PORT CHARGING CIRCUIT, DEVICE AND CONTROL METHOD

(71) Applicant: Shenzhen Ohm Microelectronics Co., Ltd., Shenzhen (CN)

(72) Inventor: Hongsheng LIN, Shenzhen (CN)

(21) Appl. No.: 18/519,058

(22) Filed: Nov. 26, 2023

(30) Foreign Application Priority Data
Dec. 12, 2022 (CN) 202211590622.5

(51) Int. Cl. H02J 7/00; H02J 9/06

(52) U.S. Cl. CPC H02J 7/0013; H02J 7/0047; H02J 9/061; H02J 9/068; H02J 2207/10; H02J 2207/30

(57) ABSTRACT

The present invention provides a multi-port charging circuit, a device, and a control method. The circuit includes: a main power supply module, a control module, a detection module, N backup power supply modules, and N power supply ports; each power supply port is connected to an output end of the main power supply module through a switch respectively; each backup power supply module is connected to the corresponding power supply port respectively. When a device is connected to the corresponding power supply port, power is supplied by the corresponding backup power supply module. Only when the power value required by the connected device exceeds the power supply capacity range of the corresponding backup power supply module, the main power supply module supplies power to the corresponding power supply port. The present invention ensures the normal charging of low-power devices while maximizing the implementation of fast charging functions of other ports.

### CROSS-REFERENCE TO THE RELATED APPLICATIONS

This application is based upon and claims priority to Chinese Patent Applications No. CN202211590622.5, filed on Dec. 12, 2022, the entire contents of which are incorporated herein by reference.

### TECHNICAL FIELD

The present invention relates to the field for charging technology, in particular, to a multi-port charging circuit, device and control method.

### BACKGROUND

The existing multi-port charging technology widely uses an architecture that shares a main power source. This architecture uses a single power supply module to supply power and can charge multiple external devices.

The commonly used power supply devices that can be configured with multiple power supply ports for external power supply, including: power strips, multi-port sockets, multi-line power banks, etc., are widely used in devices and systems with the ability to charge multiple devices simultaneously.

The existing multi-port charging generally adopts the following method: setting up an insertion detection module, determining whether the corresponding port has device access by detecting the electrical signal (such as current, voltage, etc.) through the insertion detection module, and providing power for the port with device access; and in the case of two or more ports are connected with devices at the same time, these ports are supplied with a fixed voltage.

The above existing practices have the following problems:
1) for low-power devices, due to the small value of the electrical signal during the charging process, and the limited detection accuracy of the insertion detection module, it is easy for low-power devices to be judged as light load after connecting to the corresponding power supply port, and unable to provide normal power supply to them;
2) when there are two or more power supply ports connected with devices at the same time, all devices or high-power devices among them cannot achieve fast charging because they can only be powered at a fixed voltage.

Therefore, how to achieve fast charging while ensuring the normal charging of low-power devices has become an urgent technical issue in the industry.

### SUMMARY

The present invention provides a multi-port charging circuit, device, and control method to solve the technical problem of achieving fast charging function while ensuring normal charging of low-power devices.

According to a first aspect of the present invention, a multi-port charging circuit is provided and includes: a main power supply module, a control module, a detection module, N backup power supply modules and N power supply ports, wherein N is an integer larger than or equal to 2; the power supply capability of each of the N backup power supply modules is less than that of the main power supply module; wherein, the power supply capability is represented by rated power; wherein:

each of the N power supply ports is connected to an output end of the main power supply module through a switch; the output end of each of the N backup power supply modules is connected to the corresponding power supply port; the detection module is respectively connected to the N power supply portsand the control module; the control module is connected to each of the switches;

the N backup power supply modules are configured to supply power by corresponding backup power supply modules when there are devices connected to the corresponding power supply ports;

The detection module is configured to detect the present power supply information of the power supply port of the connected device in real time and send it to the control module:
the control module is configured to:
based on the present power supply information of the corresponding power supply port, determine whether the power value required by the device connected to the corresponding power supply port is within the power supply capability range of the corresponding backup power supply module;
if so, the corresponding power supply port is powered by the corresponding backup power supply module, and the control module controls the switch between the corresponding power supply port and the main power supply module to disconnect, so that the main power supply module is used to support the power supply of other power supply ports;
if not, control the switch between the corresponding power supply port and the main power supply module to close, so that the main power supply module supplies power to the corresponding power supply port.

Optionally, the detection module includes N current detection modules, the present power supply information includes a present power supply current; a first end of each of the N current detection modules is connected to the corresponding power supply port, and the a second end of each of the N current detection modules is connected to the control module; of the N current detection modules is used to detect the present power supply current of the corresponding power supply port in real time.

Optionally, based on the present power supply information of the corresponding power supply port, the control module determine whether the power value required by the device connected to the corresponding power supply port is within the power supply capability range of the corresponding backup power supply module; specifically includes:
if the present power supply current of the corresponding power supply port is less than or equal to a rated current of the corresponding backup power supply module, it is determined that the power value required by the device connected to the corresponding power supply port is within the power supply capability range of the corresponding backup power supply module; wherein, the rated current matches the power supply current corresponding to a rated power of the corresponding backup power supply module;

If the present power supply current of the corresponding power supply port is greater than the rated current of the corresponding backup power supply module, it is determined that the power value required by the device connected to the corresponding power supply port exceeds the power supply capability range of the corresponding backup power supply module.

Optionally, the detection module also includes a voltage detection module, the present power supply information also includes a present power supply voltage; a first end of the voltage detection module is respectively connected with the N power supply ports, and the second end of the voltage detection module is connected to the control module; the voltage detection module is used to detect a present power supply voltage of each of the N power supply ports in real time.

Optionally, based on the present power supply information of the corresponding power supply port, the control module determine whether the power value required by the device connected to the corresponding power supply port is within the power supply capability range of the corresponding backup power supply module; specifically includes:
if the present power supply current of the corresponding power supply port is less than or equal to a rated current of the corresponding backup power supply module, it is determined that the power value required by the device connected to the corresponding power supply port is within the power supply capability range of the corresponding backup power supply module; wherein, the rated current matches a power supply current corresponding to a rated power of the corresponding backup power supply module;
if the present power supply current of the corresponding power supply port is greater than the rated current of the corresponding backup power supply module, or if the present power supply voltage of the corresponding power supply port drops below a preset voltage and lasts for a preset time, or if the product of the present power supply voltage and the present power supply current of the corresponding power supply port exceeds the rated power of the corresponding backup power supply module, it is determined that the power value required by the device connected to the corresponding power supply port exceeds the power supply capability range of the corresponding backup power supply module.

Optionally, the control module is also configured to:
when the number of power supply ports simultaneously powered by the main power supply module is one, control the output voltage of the main power supply module to be adjustable, so that to support the fast charging of the corresponding power supply port.

Optionally, the control module is also configured to:
when the number of power supply ports powered by the main power supply module is two or more, control the main power supply module to output a fixed voltage.

Optionally, the multi-port charging circuit also includes N DC/DC converters, each of the N DC/DC converters is connected between the main power supply module and the corresponding switch, each of the N DC/DC converters is used to transform a fixed voltage when the main power supply module outputs the fixed voltage, so that to output the transformed voltage to the corresponding power supply port.

Optionally, the control module is also configured to:
after the switch between the corresponding power supply port and the main power supply module is closed, disable the backup power supply module to supply power to the corresponding power supply port.

Optionally, the switch is a MOS transistor, the control module is connected to the gate of the MOS transistor.

Optionally, the power supply port includes a USB TYPE-A interface or a USB TYPE-C interface.

According to a second aspect of the present invention, an electronic device is provided and includes the multi-port charging circuit disclosed in the first aspect of the present invention and its optional embodiments.

According to a third aspect of the present invention, a control method is provided, it is applied to control the multi-port charging circuit disclosed in the first aspect of the present invention and its optional embodiments, the method includes:
detecting the present power supply information of the power supply port of the connected device in real-time;
based on the present power supply information of the corresponding power supply port, determining whether the required power value of the device connected to the corresponding power supply port is within the power supply capability range of the corresponding backup power supply module;
if so, the corresponding power supply port is powered by the corresponding backup power supply module, and controlling the switch between the corresponding power supply port and the main power supply module to disconnect, so that the main power supply module is used to support the power supply of other power supply port;
if not, controlling the switch between the corresponding power supply port and the main power supply module to close, so that the main power supply module supplies power to the corresponding power supply port.

In the multi-port charging circuit, device, and control method provided by the present invention, each power supply port is separately connected to the output end of the main power supply module through a switch, and the output ends of each backup power supply module are respectively connected to the corresponding power supply ports. This enables that when a device is connected to the corresponding power supply port, the corresponding backup power supply module supplies power to the corresponding power supply port. Only when the power value required by the connected device exceeds the power supply capacity range of the corresponding backup power supply module, the control module controls the corresponding switch to close, so the main power supply module supplies power to the corresponding power supply port. Therefore, for the multi-port power supply technology, the present invention ensures normal charging of low-power devices while maximizing the implementation of fast charging functions for other ports.

### BRIEF DESCRIPTION OF DRAWINGS

In order to illustrate the technical solutions in the embodiments according to the present disclosure or in the prior art more clearly, a brief introduction may be given hereinafter to the accompany drawings required to be used in the description of the embodiments or the prior art. Apparently, the accompany drawings in the description below are merely some embodiments of the present disclosure, and other accompany drawings may be obtained by those of ordinary skilled in the art according to these accompany drawings without paying any creativelabor.

FIG. 1 is a first schematic diagram of the circuit structure of the multi-port charging circuit in an embodiment of the present invention;

FIG. 2 is a second schematic diagram of the circuit structure of the multi-port charging circuit in an embodiment of the present invention;

FIG. 3 is a third schematic diagram of the circuit structure of the multi-port charging circuit in an embodiment of the present invention;

FIG. 4 is a fourth schematic diagram of the circuit structure of the multi-port charging circuit in an embodiment of the present invention;

FIG. 5 is a first flowchart of the control method of the multi-port charging circuit in an embodiment of the present invention;

FIG. 6 is a second flowchart of the control method of the multi-port charging circuit in an embodiment of the present invention.

### DESCRIPTION OF REFERENCE SIGNS

11-Main power supply module;
12-Backup power supply module;
13-Detection module;
131-Current detection module;
132-Voltage detection module;
14-Control module;
15-Power supply port;
16-Voltage converter;

### DETAILED DESCRIPTION OF THE EMBODIMENTS

The technical solutions in the embodiments of the present disclosure will be clearly and completely described below in conjunction with the accompanying drawings in the embodiments of the present disclosure. It is obvious that the described embodiments are only part but not all of the embodiments of the present disclosure. All other embodiments obtained by those skilled in the art without creative efforts based on the embodiments in the present disclosure are within the protection scope of the present disclosure

The terms “first”, “second”, “third”, “fourth”, etc. (if any) in the specification, claims, and above-mentioned drawings of the invention are used to distinguish similar objects, not necessarily to describe a specific order or sequence. It should be understood that the data used in this way can be interchanged as appropriate so that the embodiments of the invention described here can be implemented in an order other than those illustrated or described here. In addition, the terms “include” and “have” and their variations are intended to cover non-exclusive inclusion, for example, a process, method, system, product or device that includes a series of steps or units does not necessarily have to be limited to those steps or units that are clearly listed, but can include other steps or units that are not clearly listed or inherent to these processes, methods, products or devices.

The technical solutions of the present invention are described in detail below with specific embodiments. The following specific embodiments may be combined with each other, and the same or similar concepts or processes may not be repeated in some embodiments.

In view of that in the prior art, it is difficult to achieve fast charging while ensuring normal charging of low-power devices. The present invention provides a multi-port charging circuit, including a main power supply module and N backup power supply modules, each of the N backup power supply modules corresponds to a power supply port; when the corresponding power supply port is plugged in with a device, it is defaulted to be powered by the corresponding backup power supply module, and when the power value required by the device connected to the corresponding power supply port does not exceed the power supply capability range of the corresponding backup power supply module, the main power supply module does not need to supply power to the power supply port, thus ensuring that low-power devices can always be powered, and the main power supply module can fully support other power supply ports, which is conducive to the implementation of the fast charging function of other ports.

In addition, when the power value required by the device connected to the corresponding power supply port exceeds the power supply capability range of the corresponding backup power supply module, the main power supply module is controlled to supply power to the corresponding power supply port, to ensure that high-power devices can get relatively sufficient power supply.

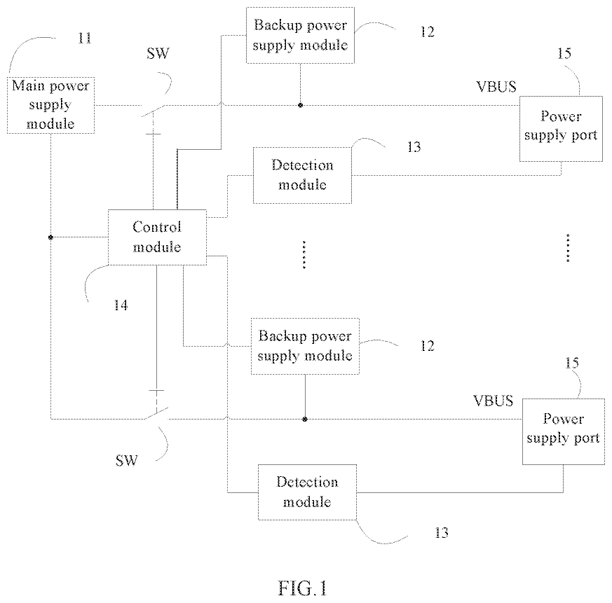

Please refer to FIG. 1, an embodiment of the present invention provides a multi-port charging circuit, including a main power supply module 11, a control module 14, a detection module 13, N backup power supply modules 12, and N power supply ports 15, wherein N is an integer larger than or equal to 2; each backup power supply module 12 has a power supply capability less than that of the main power supply module 11; wherein, the power supply capability is represented by the rated power; wherein:

each power supply port 15 is connected to the output end of the main power supply module 11 through a switch SW; the output end of each backup power supply module 12 is connected to the corresponding power supply port 15; when a device is connected to the corresponding power supply port 15, the corresponding backup power supply module 12 provides power. The detection module 13 connects the N power supply ports 15 and the control module 14; the control module 14 is connected to each switch SW.

The detection module 13 is used to detect the present power supply information of the power supply port 15 of the connected device in real time and send it to the control module 14. The control module 14 determines whether the power value required by the device connected to the corresponding power supply port 15 is within the power supply capability range of the corresponding backup power supply module 12 based on the present power supply information of the corresponding power supply port 15; if so, the corresponding power supply port is powered by the corresponding backup power supply module 12, and the control module 14 controls the switch SW between the corresponding power supply port and the main power supply module to disconnect, so that the main power supply module 11 is used to support the power supply of other power supply ports; if not, the control module controls the switch between the corresponding power supply port and the main power supply module to close, so that the main power supply module supplies power to the corresponding power supply port.

Wherein, the control module 14 is connected to the control end of the switch SW; the control module 14 sends a corresponding control signal to the control end of the corresponding switch SW according to the present power supply information of the corresponding power supply port 15 to control the on-off of the corresponding switch; wherein, the transmission of the control signal can be a wireless transmission method, of course, it can also be a wired transmission method, the present invention does not make any restrictions on this.

As an example, the switch SW can be a MOS switch transistor, the control module 14 is connected to the gate of the MOS transistor and sends a control signal to control the on-off of the MOS transistor. Of course, the present invention is not limited to this, in other examples, the switch SW can also choose a triode or other switching devices.

In the example shown in FIG. 1, the output end of the main power supply module 11 is directly connected to each power supply port 15 via a corresponding switch SW. In this case, when the number of the power supply ports 15 simultaneously powered by the main power supply module 11 is one, the output voltage of the main power supply module 11 can be adjusted to support the fast charging of the device connected to the corresponding power supply port 15. Specifically, the control module 14 controls the voltage output by the main power supply module 11 based on the device condition of the corresponding power supply port 15, to support the fast charging of the device connected to the corresponding power supply port 15. However, when the number of power supply ports 15 simultaneously powered by the main power supply module 11 is more than two, the control module 14 controls the main power supply module 11 to output a fixed voltage, to supply power to each power supply port 15 that needs the main power supply module 11 to supply power with this fixed voltage.

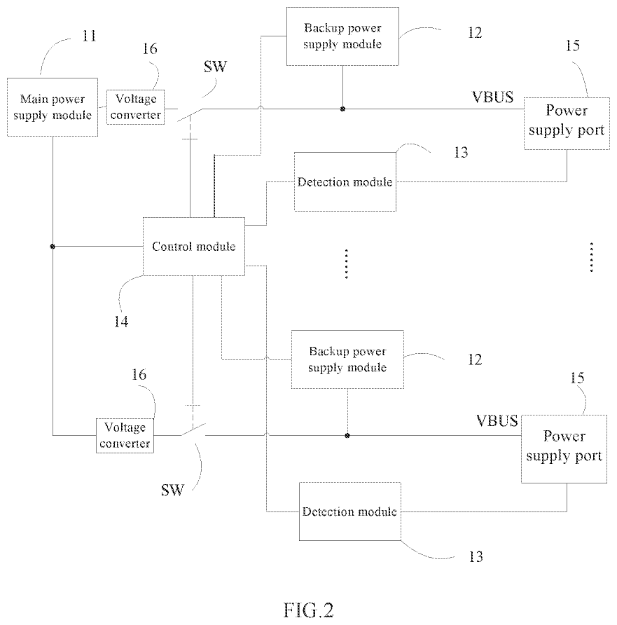

As a further preferred embodiment, please refer to FIG. 2, in order to still achieve differentiated power supply when the number of devices simultaneously powered by the main power supply module reaches more than two, to meet the needs of power supply devices of different power, the multi-port charging circuit also includes N voltage converters 16, and one voltage converter 16 is set between the main power supply module 11 and the corresponding switch SW, the main power supply module 11 is connected to the corresponding switch SW through the corresponding voltage converter 16.

As an example, the voltage converter 16 can be a DC/DC converter, each DC/DC converter is used to independently transform the fixed voltage when the main power supply module 11 outputs a fixed voltage, to meet the needs of the corresponding power supply port. Thus, even if the number of power supply ports 15 powered by the main power supply module 11 is more than two, the power supply of these power supply ports can still achieve differentiation, so that the voltage after transformation can meet the power supply needs of each electric device, to achieve power distribution according to demand.

Of course, it should be realized that the device and position of the above-mentioned voltage converter 16 in the circuit are only examples, the voltage converter 16 in this invention is not limited to being installed between the main power supply module 11 and the corresponding switch, as an example, it can also be set between the corresponding switch and the corresponding power supply port. That is, as long as the voltage converter 16 can independently change the voltage of each power supply branch in the circuit, it is within the protection scope of this invention.

The power supply port 15 can be a USB TYPE-A interface or a USB TYPE-C interface. This invention does not limit the interface type of the power supply port 15, any foreseeable interface that supports fast charging is within the protection scope of this invention.

As a preferred method, the control module 14 is also configured to: after the switch between the corresponding power supply port and the main power supply module is closed, disable the backup power supply module 12 to supply power to the power supply port, thus saving energy. The specific disable method can be, for example, the control module 14 closes the corresponding backup power supply module 12, so that the corresponding backup power supply module 12 does not work. Of course, this invention does not make any restrictions on the specific disable method.

Regarding the detection module 13, the specific explanation is as follows:

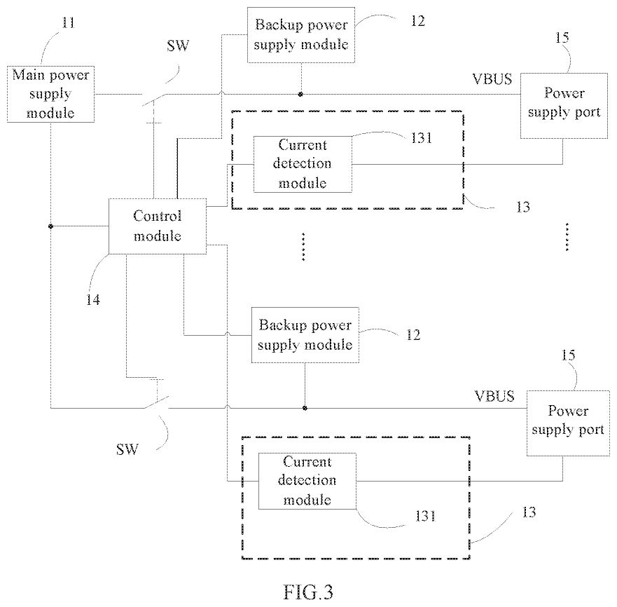

In one example, please refer to FIG. 3, the detection module 13 includes N current detection modules 131, a first end of each current detection module 131 is connected to the corresponding power supply port 15, and a second end of each current detection module 131 is connected to the control module 14; each current detection module 131 is used to detect the present power supply current of the corresponding power supply port 15 in real time. The present power supply information of the corresponding power supply port 15 is the current flowing through the power supply port 15.

In this case, the control module 14 determines whether the power value required by the device connected to the corresponding power supply port is within the power supply capacity range of the corresponding backup power supply module based on the present power supply information of the corresponding power supply port; specifically includes:

If the present power supply current of the corresponding power supply port is less than or equal to a rated current of the corresponding backup power supply module, it is determined that the power value required by the device connected to the corresponding power supply port is within the power supply capacity range of the corresponding backup power supply module; wherein the rated current matches to the power supply current corresponding to the rated power of the corresponding backup power supply module;

If the present power supply current of the corresponding power supply port is greater than the rated current of the corresponding backup power supply module, it is determined that the power value required by the device connected to the corresponding power supply port exceeds the power supply capacity range of the corresponding backup power supply module.

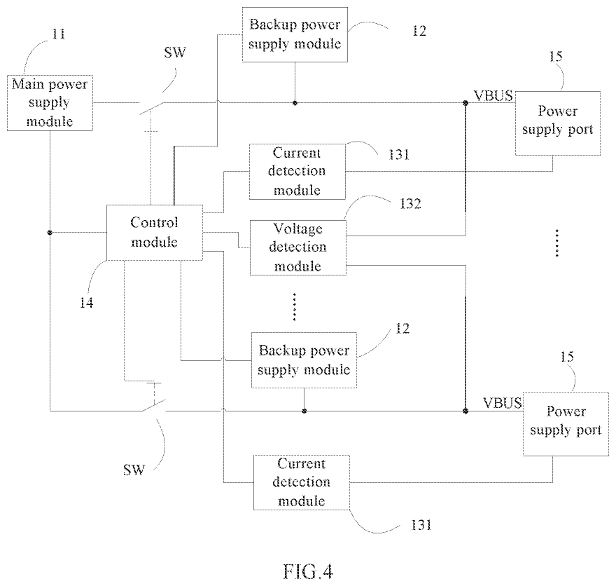

As a preferred mode, in addition to including N current detection modules 131, the detection module 13 also includes a voltage detection module 132; the present power supply information includes the present power supply current and the present power supply voltage; please refer to FIG. 4, a first end of each current detection module 131 is connected to the corresponding power supply port 15, and a second end of each current detection module 131 is connected to the control module 14. A first end of the voltage detection module 132 is connected to the corresponding N power supply ports 15 respectively, and a second end of the voltage detection module 132 is connected to the control module 14; specifically, the N power supply ports 15 are connected to the first end of the voltage detection module 132 through different detection lines. Each current detection module 131 is used for real-time detection of the present power supply current of the corresponding power supply port 15; the voltage detection module 132 is used for real-time detection of the present power supply voltage of each power supply port 15. Here, the present power supply current refers to the current flowing through the corresponding power supply port 15, and the present power supply voltage refers to the voltage of the VBUS of the corresponding power supply port 15, wherein VBUS is the voltage on the power supply pin of the corresponding power supply port 15.

It should be understood that in the embodiment shown in FIG. 4, by connecting the VBUS pins of the N power supply ports 15 to the measurement end of the voltage detection module through different detection lines, the N power supply ports 15 share a voltage detection module; this is just a preferred embodiment of the present invention. The present invention does not limit the number of voltage detection modules, and those skilled in the art can choose other connection methods according to actual conditions, such as multiple voltage detection modules, different power supply ports correspond to different voltage detection modules.

In this case, the control module 14 determines whether the power value required by the device connected to the corresponding power supply port is within the power supply capacity range of the corresponding backup power supply module based on the present power supply information of the corresponding power supply port; specifically includes:

If the present power supply current of the corresponding power supply port is less than or equal to the rated current of the corresponding backup power supply module, it is determined that the power value required by the device connected to the corresponding power supply port is within the power supply capacity range of the corresponding backup power supply module; wherein the rated current matches the power supply current corresponding to the rated power of the corresponding backup power supply module;

If the present power supply current of the corresponding power supply port is greater than the rated current of the corresponding backup power supply module, or if the present power supply voltage of the corresponding power supply port drops below a preset voltage and lasts for a preset time, or if the product of the present power supply voltage and the present power supply current of the corresponding power supply port exceeds the rated power of the backup power supply module, it is determined that the power value required by the device connected to the corresponding power supply port exceeds the power supply capacity range of the corresponding backup power supply module.

For the case where the detection module 13 shown in FIG. 4 is used, as a preferred embodiment, the present power supply current of the corresponding power supply port and the rated current of the corresponding backup power supply module are used to determine whether the power supply is maintained by the backup power supply module and whether the power supply is switched from the main power supply module to the backup power supply module; and the voltage change of the VBUS of the corresponding power supply port is used to determine whether the power supply is switched from the backup power supply module to the main power supply module.

This is because a drop in voltage can indicate that the backup power supply module cannot provide power, i.e., it exceeds the power supply capacity of the backup power supply module, and it is necessary to switch from the backup power supply module to the main power supply module for power supply. Because voltage drops are easier to capture, they can help improve the accuracy of the judgment. Furthermore, as a further preferred embodiment, in order to avoid interference caused by normal voltage disturbances, it can be determined that the backup power supply module cannot supply power when the present supply voltage of the power supply port drops below a preset voltage and lasts for a preset time. Since normal voltage disturbances usually disappear in a short period of time, it can eliminate the interference of normal voltage disturbances and further improve the accuracy of the judgment by introducing a preset time.

The value of the present supply current is used to determine whether it is necessary to switch from the main power supply module to the backup power supply module for power supply. This is because the relationship between the value of the present supply current and the threshold current (the rated current of the backup power supply module) can be directly used for judgment, which is relatively simple and clear; if the present supply current is lower than the threshold current, it is a small current, and it needs to be switched to the backup power supply module for power supply; if the present supply current is higher than the threshold current, it is a large current, and the main power supply module continues to supply power.

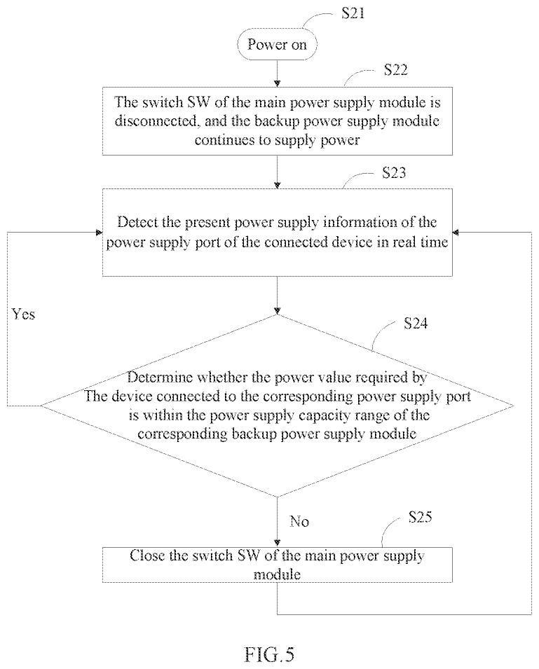

In addition, please refer to FIG. 5, an embodiment of the present invention also provides a control method for controlling the multi-port charging circuit shown in FIG. 1, the control method includes the following steps:
S21: Power on;
The multi-port charging circuit works normally after power on;
S22: The switch SW of the main power supply module is disconnected, and the backup power supply module continues to supply power;
Wherein, step S22 can be understood as: when a corresponding power supply port is connected to a device, the corresponding backup power supply module is controlled to supply power, and the switch SW of the main control module is disconnected;
S23: Detect the present power supply information of the power supply port of the connected device in real time; Specifically, the detection module 13 detects the power supply information of the corresponding power supply port 15 in real time and transmits it to the control module 14;
S24: Determine whether the power value required by the device connected to the corresponding power supply port is within the power supply capacity range of the corresponding backup power supply module; if yes, return to S23; if no, enter to S25;
Specifically, the control module 14 determines whether the power value required by the power supply port 15 is within the power supply capacity range of the corresponding backup power supply module based on the present power supply information of the corresponding power supply port 15. If yes, maintain the current power supply status, that is, control the corresponding power supply port 15 to continue to be powered by the corresponding backup power supply module, and control the switch SW between the corresponding power supply port 15 and the main power supply module 11 to be disconnected, so that the main power supply module 11 is used to support the power supply of other power supply ports 15, and return to step S23 for the detection module 13 to continue to detect the power supply information of the corresponding power supply port 15;
If no, then enter to $25;
S25: Close the switch SW of the main power supply module and return to S23.

Specifically, control the switch SW between the corresponding power supply port 15 and the main power supply module 11 to close, so that the main power supply module 11 supplies power to the corresponding power supply port 15, and return to S23 for the detection module 13 to continue to detect the power supply information of the corresponding power supply port 15.

Wherein, as one implementation method, the present power supply information in step S24 is the current flowing through the power supply port. Then in this case, in step S24, determining whether the power value required by the device connected to the corresponding power supply port 15 exceeds the power supply capacity range of the corresponding backup power supply module 12, specifically as follows:
If the present power supply current of the corresponding power supply port 15 is less than or equal to the rated current of the corresponding backup power supply module 12, it is determined that the power value required by the device connected to the corresponding power supply port 15 is within the power supply capacity range of the corresponding backup power supply module 12;
If the present power supply current of the corresponding power supply port 15 is greater than the rated current of the corresponding backup power supply module 12, it is determined that the power value required by the device connected to the corresponding power supply port 15 exceeds the power supply capacity range of the corresponding backup power supply module 12;
Wherein, the rated current can be understood as the power supply current corresponding to the rated power of the corresponding backup power supply module.

Wherein, as another implementation method, the present power supply information in step S24 is the current flowing through the power supply port 15 and the present power supply voltage of the power supply port 15. Then in this case, in step S24, determining whether the power value required by the device connected to the corresponding power supply port 15 exceeds the power supply capacity range of the corresponding backup power supply module 12, specifically as follows:
If the present power supply current of the corresponding power supply port 15 is less than or equal to the rated current of the corresponding backup power supply module 12, it is determined that the power value required by the device connected to the corresponding power supply port is within the power supply capacity range of the corresponding backup power supply module;
If the present power supply current of the corresponding power supply port 15 is greater than the rated current of the corresponding backup power supply module 12, or if the present power supply voltage of the corresponding power supply port 15 drops to a preset voltage below and lasts for a preset time, or if the product of the present power supply voltage and the present power supply current of the corresponding power supply port 15 exceeds the rated power of the backup power supply module, it is determined that the power value required by the device connected to the corresponding power supply port 15 exceeds the power supply capacity range of the corresponding backup power supply module.

Wherein, as one implementation method, step $25 specifically can include: when the power value required by the device connected to the corresponding power supply port 15 exceeds the power supply capacity range of the corresponding backup power supply module, the backup power supply module 12 of the branch and the main power supply 11 together supply power to the connected device.

Wherein, as another implementation method, step $25 specifically can include: when the power value required by the device connected to the corresponding power supply port 15 exceeds the power supply capacity range of the corresponding backup power supply module 12, while controlling the corresponding switch SW to close, the control module 14 controls the corresponding backup power supply module 12 to stop supplying power to the connected device, and the main power supply module 11 supplies power to the connected device.

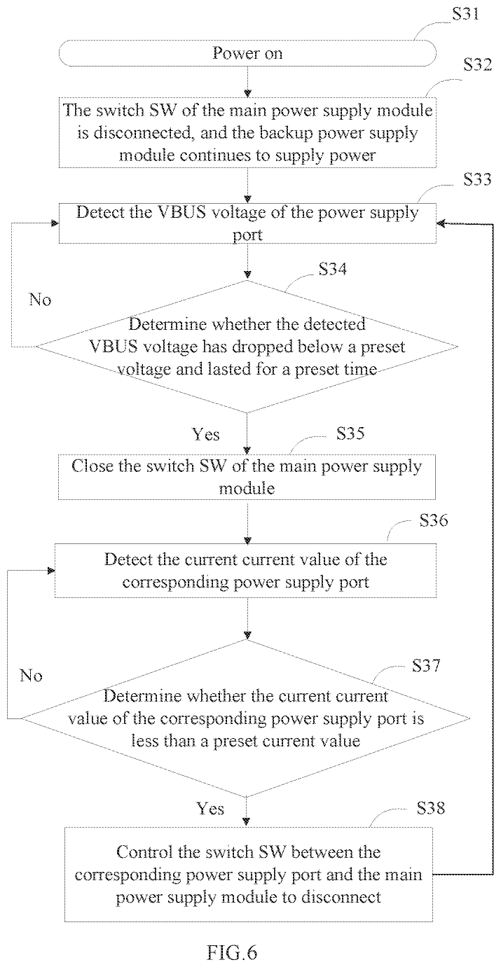

As a further preferred embodiment, when the present power supply information is the current flowing through the power supply port 15 and the VBUS voltage of the power supply port 15, in the control method, whether to maintain power supply by the backup power supply module and whether to switch from power supply by the main power supply module to power supply by the backup power supply module can be determined by the value of the present power supply current of the corresponding power supply port and the rated current of the corresponding backup power supply module; and whether to switch from power supply by the backup power supply module to power supply by the main power supply module can be determined by the change of the VBUS voltage of the corresponding power supply port. Specifically, as shown in FIG. 6, this preferred control method specifically includes the following steps:
S31: Power on;
The multi-port charging circuit works normally after power on;
S32: The switch SW of the main power supply module is disconnected, and the backup power supply module continues to supply power;
Wherein, step S22 can be understood as: when the corresponding power supply port 15 is connected to a device, the corresponding backup power supply module 12 is controlled to provide the power supply, and the switch SW of the main control module is disconnected;
S33: Detect the VBUS voltage of the power supply port;
Specifically, the detection module 13 detects the VBUS voltage of the corresponding power supply port 15 and transmits the power supply information to the control module 14;
S34: Determine whether the detected VBUS voltage has dropped below a preset voltage and lasted for a preset time; if yes, then enter to S35; if no, then return to S33; Specifically, the control module 14 determines whether the power value required by the device connected to the corresponding power supply port 15 is within the power supply capacity range of the corresponding backup power supply module 12 based on the change in the VBUS voltage of the corresponding power supply port 15;
If the VBUS voltage of the corresponding power supply port 15 drops below a preset voltage and lasts for a preset time, it indicates that the power value required by the device connected to the corresponding power supply port 15 exceeds the power supply capacity range of the corresponding backup power supply module 12, causing the VBUS voltage to drop, and then enter to S35;
If the VBUS voltage of the corresponding power supply port 15 does not drop, or if the drop in VBUS voltage lasts for less than the preset time, it indicates that the power value required by the device connected to the corresponding power supply port 15 does not exceed the power supply capacity range of the corresponding backup power supply module 12, then control the corresponding power supply port 15 to maintain power supply by the corresponding backup power supply module 12, and maintain the switch SW between the corresponding power supply port 15 and the main power supply module 11 disconnected, so that the main power supply module 11 is used to support the power supply of other power supply ports 15, and the detection module continues to detect the VBUS voltage of the corresponding power supply port 15;
S35: Close the switch SW of the main power supply module; Specifically, control the switch SW between the corresponding power supply port 15 and the main power supply module 11 to close; so that the main power supply module 11 supplies power to the corresponding power supply port 15;
S36: Detect the present current value of the corresponding power supply port;
Specifically, when the power value required by the device connected to the corresponding power supply port 15 exceeds the power supply capacity range of the corresponding backup power supply module 12, the detection module 13 detects the present power supply current of the corresponding power supply port 15 and transmits the power supply information to the control module 14;
S37: Determine whether the present current value of the corresponding power supply port is less than a preset current value; if yes, then enter S38; if no, then return to S36;
Specifically, the control module 14 determines whether the power value required by the device connected to the corresponding power supply port 15 is within the power supply capacity range of the corresponding backup power supply module 12 based on the present power supply current of the corresponding power supply port 15;
If the present power supply current of the corresponding power supply port 15 is less than or equal to the rated current of the corresponding backup power supply module 12, it is determined that the power value required by the device connected to the corresponding power supply port 15 is within the power supply capacity range of the corresponding backup power supply module 12, and enter S38; If the present power supply current of the corresponding power supply port 15 is greater than the rated current of the corresponding backup power supply module 12, it is determined that the power value required by the device connected to the corresponding power supply port 15 still exceeds the power supply capacity range of the corresponding backup power supply module 12, then maintain the switch SW between the corresponding power supply port 15 and the main power supply module 11 closed, so that the main power supply module 11 supplies power to the corresponding power supply port 15, and return to S36, with the detection module continuing to detect the present power supply current of the corresponding power supply port 15.

S38: Control the switch SW between the corresponding power supply port and the main power supply module to disconnect, and return to S33.

In addition, the embodiment of the present invention also provides an electronic device, which includes the above-mentioned multi-port charging circuit. As an example, the device can be a power strip, a socket with multiple plugs, a multi-line power bank, and of course, it can also be other devices that need to supply power to multiple ports.

Finally, it should be noted that the above embodiments are only used to illustrate the technical solutions of the present invention, but not to limit the present invention. Although the present invention has been described in detail with reference to the foregoing embodiments, a person of ordinary skill in the art shall understand that modifications may be made to the technical solutions described in the foregoing embodiments, or some or all of the technical features thereof may be equivalently substituted. However, these modifications or substitutions do not essentially depart the corresponding technical solutions from the scope of the technical solutions of the embodiments of the present invention

What is claimed is:

1. A multi-port charging circuit, including: a main power supply module, a control module, a detection module, N backup power supply modules and N power supply ports, wherein N is an integer larger than or equal to 2; the power supply capability of each of the N backup power supply modules is less than that of the main power supply module; the power supply capability is represented by a rated power; wherein:
each of the N power supply ports is connected to an output end of the main power supply module through a switch; an output end of each of the N backup power supply modules is connected to a corresponding power supply port; the detection module is respectively connected to the N power supply ports and the control module; the control module is connected to each of the switches;
the N backup power supply modules are configured to supply power by corresponding backup power supply modules when there are devices connected to the corresponding power supply ports;
the detection module is configured to detect the present power supply information of the power supply ports connected with corresponding devices in real time and send it to the control module;
the control module is configured to:
based on the present power supply information of the corresponding power supply port, determine whether the power value required by the device connected to the corresponding power supply port is within the power supply capability range of the corresponding backup power supply module;
if so, the corresponding power supply port is powered by the corresponding backup power supply module, and the control module controls the switch between the corresponding power supply port and the main power supply module to disconnect, so that the main power supply module is used to support the power supply of other power supply ports;
if not, control the switch between the corresponding power supply port and the main power supply module to close, so that the main power supply module supplies power to the corresponding power supply port.

2. The multi-port charging circuit according to claim 1, wherein the detection module includes N current detection modules, the present power supply information includes a present power supply current; a first end of each of the N current detection modules is connected to the corresponding power supply port, and a second end of each of the N current detection modules is connected to the control module; cach of the N current detection modules is used to detect the present power supply current of the corresponding power supply port in real time.

3. The multi-port charging circuit according to claim 2, wherein based on the present power supply information of the corresponding power supply port, the control module determine whether the power value required by the device connected to the corresponding power supply port is within the power supply capability range of the corresponding backup power supply module; specifically includes:
if the present power supply current of the corresponding power supply port is less than or equal to a rated current of the corresponding backup power supply module, it is determined that the power value required by the device connected to the corresponding power supply port is within the power supply capability range of the corresponding backup power supply module; wherein, the rated current matches the power supply current corresponding to a rated power of the corresponding backup power supply module;
If the present power supply current of the corresponding power supply port is greater than the rated current of the corresponding backup power supply module, it is determined that the power value required by the device connected to the corresponding power supply port exceeds the power supply capability range of the corresponding backup power supply module.

4. The multi-port charging circuit according to claim 2, wherein the detection module also includes a voltage detection module, the present power supply information also includes a present power supply voltage; a first end of the voltage detection module is respectively connected with the N power supply ports, and the second end of the voltage detection module is connected to the control module; the voltage detection module is used to detect a present power supply voltage of each of the N power supply ports in real time.

5. The multi-port charging circuit according to claim 4, wherein based on the present power supply information of the corresponding power supply port, the control module determine whether the power value required by the device connected to the corresponding power supply port is within the power supply capability range of the corresponding backup power supply module; specifically includes:
if the present power supply current of the corresponding power supply port is less than or equal to a rated current of the corresponding backup power supply module, it is determined that the power value required by the device connected to the corresponding power supply port is within the power supply capability range of the corresponding backup power supply module; wherein, the rated current matches a power supply current corresponding to a rated power of the corresponding backup power supply module;
if the present power supply current of the corresponding power supply port is greater than the rated current of the corresponding backup power supply module, or if the present power supply voltage of the corresponding power supply port drops below a preset voltage and lasts for a preset time, or if the product of the present power supply voltage and the present power supply current of the corresponding power supply port exceeds the rated power of the corresponding backup power supply module, it is determined that the power value required by the device connected to the corresponding power supply port exceeds the power supply capability range of the corresponding backup power supply module.

6. The multi-port charging circuit according to claim 1, wherein the control module is also configured to:
when the number of power supply ports simultaneously powered by the main power supply module is one, control the output voltage of the main power supply module to be adjustable, so that to support the fast charging of the corresponding power supply port.

7. The multi-port charging circuit according to claim 2, wherein the control module is also configured to:
when the number of power supply ports simultaneously powered by the main power supply module is one, control the output voltage of the main power supply module to be adjustable, so that to support the fast charging of the corresponding power supply port.

8. The multi-port charging circuit according to claim 3, wherein the control module is also configured to:
when the number of power supply ports simultaneously powered by the main power supply module is one, control the output voltage of the main power supply module to be adjustable, so that to support the fast charging of the corresponding power supply port.

9. The multi-port charging circuit according to claim 4, wherein the control module is also configured to:
when the number of power supply ports simultaneously powered by the main power supply module is one, control the output voltage of the main power supply module to be adjustable, so that to support the fast charging of the corresponding power supply port.

10. The multi-port charging circuit according to claim 5, wherein the control module is also configured to:
when the number of power supply ports simultaneously powered by the main power supply module is one, control the output voltage of the main power supply module to be adjustable, so that to support the fast charging of the corresponding power supply port.

11. The multi-port charging circuit according to claim 6, wherein the control module is also configured to:
when the number of power supply ports powered by the main power supply module is two or more, control the main power supply module to output a fixed voltage.

12. The multi-port charging circuit according to claim 11, wherein the multi-port charging circuit also includes N DC/DC converters, each of the N DC/DC converters is connected between the main power supply module and the corresponding switch, each of the N DC/DC converters is used to transform a fixed voltage when the main power supply module outputs the fixed voltage, so that to output the transformed voltage to the corresponding power supply port.

13. The multi-port charging circuit according to claim 1, wherein the control module is also configured to:
after the switch between the corresponding power supply port and the main power supply module is closed, disable the backup power supply module to supply power to the corresponding power supply port.

14. The multi-port charging circuit according to claim 2, wherein the control module is also configured to:
after the switch between the corresponding power supply port and the main power supply module is closed, disable the backup power supply module to supply power to the corresponding power supply port.

15. The multi-port charging circuit according to claim 3, wherein the control module is also configured to:
after the switch between the corresponding power supply port and the main power supply module is closed, disable the backup power supply module to supply power to the corresponding power supply port.

16. The multi-port charging circuit according to claim 4, wherein the control module is also configured to:
after the switch between the corresponding power supply port and the main power supply module is closed, disable the backup power supply module to supply power to the corresponding power supply port.

17. The multi-port charging circuit according to claim 1, wherein the switch is a MOS transistor, the control module is connected to the gate of the MOS transistor.

18. The multi-port charging circuit according to claim 1, wherein the power supply port includes a USB TYPE-A interface or a USB TYPE-C interface.

19. An electronic device comprising the multi-port charging circuit according to claim 1.

20. A control method, applied to control the multi-port charging circuit according to claim 1, and the method includes:
when any power supply port is connected to a device, controlling the corresponding power supply port to be powered by the corresponding backup power supply module;
detecting the present power supply information of the power supply port of the connected device in real-time;
based on the present power supply information of the corresponding power supply port, determining whether the required power value of the device connected to the corresponding power supply port is within the power supply capability range of the corresponding backup power supply module;
if so, the corresponding power supply port is powered by the corresponding backup power supply module, and controlling the switch between the corresponding power supply port and the main power supply module to disconnect, so that the main power supply module is used to support the power supply of other power supply port;
if not, controlling the switch between the corresponding power supply port and the main power supply module to close, so that the main power supply module supplies power to the corresponding power supply port.
